(19) United States
(12) Patent Application Publication
(10) Pub. No.: US 2008/0147427 A1
(43) Pub. Date: Jun. 19, 2008

(54) COMPLAINT PROCESSING METHOD AND APPARATUS

(75) Inventor: Yasuyuki Terui, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/861,890

(22) Filed: Sep. 26, 2007

(30) Foreign Application Priority Data
Dec. 18, 2006 (JP) 2006-340447

(51) Int. Cl. G06Q 10/00

(52) U.S. Cl. 705/1

(57) ABSTRACT

A complaint processing method includes: receiving a complaint input instruction from a user terminal; obtaining position information of the user terminal; searching, based on the position information of the user terminal, a first data storage storing items of complaints that may occur in association with position information to identify items of complaints that may occur and correspond to the position information of the user terminal; transmitting the identified items of the complaints that may occur and correspond to the position information of the user terminal to the user terminal; and receiving information concerning a selected item of the complaint from the user terminal, and storing the information concerning the selected item of the complaint into a second data storage. By carrying out such a method, because items of complaints having high possibility to be selected are displayed when the customer feels the grumble, the customer easily select a complaint, and it becomes possible for the store to listen to a lot of complaints and take appropriate actions against them.

### TECHNICAL FIELD OF THE INVENTION

This invention relates to an information processing technique for complaints in a store or the like.

### BACKGROUND OF THE INVENTION

There is a case where a customer feels complaint and discomfort during the shopping in a supermarket or the like. Therefore, the store currently prepares questionnaire papers or the like to prompt the customer to write and submit the questionnaire paper or the like. Then, the store reads the questionnaire paper, and writes the apology onto the paper to post it on the board or the like.

In addition, for example, JP-A-2002-259806 discloses a technique enabling to provide store information matching with the present user's purpose among plural items of the store information, which is prepared in advance, while tempering not only the past user's purchase history information with but also information obtained at the connection (position, time, and purpose and the like). Specifically, only information of stores to which the user can actually visit is extracted from position information of the terminal, and the information of the stores is provided according to the position information. In addition, by handling the position information as a default value of a time, a position, a purpose or an operational attribute to search a store requested by the user, the information of the store by which the information of the store to be searched can be narrowed is provided. However, notification of the aforementioned complaint and discomfort to the store is not considered in this publication.

Because it takes time to write the complaint and the like onto the aforementioned questionnaire paper, almost all the customers do not write the complaint and the like even if they feels the complaint and the like. Therefore, the store cannot find the complaint, and there is a case where the customers are away from the store while the store does not realize the complaints.

### SUMMARY OF THE INVENTION

Therefore, an object of this invention is to provide an information processing technique enabling to easily input complaints and grumbles.

In addition, another object of this invention is to provide an information processing technique enabling speedy treatment according to the complaint content.

A complaint processing method according to this invention includes: receiving a complaint input instruction from a user terminal; obtaining position information of the user terminal; searching, based on the position information of the user terminal, a first data storage storing items of complaints that may occur in association with position information to identify items of complaints that may occur and correspond to the position information of the user terminal; transmitting the identified items of the complaints that may occur and correspond to the position information of the user terminal to the user terminal; and receiving information concerning a selected item of the complaint from the user terminal and storing the information concerning the selected item of the complaint into a second data storage.

By carrying out such a processing, because items of complaints having high possibility to be selected are displayed when the customer feels the grumble, the customer easily select a complaint, and it becomes possible for the store to listen to a lot of complaints and take appropriate actions.

In addition, the aforementioned obtaining may include obtaining past position information of the user terminal, and storing the past position information into a position information storage. At that time, the aforementioned searching may include searching, based on the past position information of the user terminal, the first data storage to identify items of complaints that may occur and correspond to the past position information of the user terminal. Then, this invention may further include arranging the identified items of the complaint that may occur in an ascending order of an elapsed time.

Thus, not only when the customer inputs the complaint immediately after he or she feels the complaint, but also when the customer traces back complaints in a moving route in the store, it is possible to present the items of the complaints for the customer in a natural form.

Furthermore, the aforementioned obtaining may include obtaining past position information of the user terminal and passage time information, and storing the information into the position information storage. At that time, the searching may include searching, based on the past position information of the user terminal, the first data storage to identify items of complaints that may occur and correspond to the past position information of the user terminal. Then, this invention may further include: arranging the identified items of the complaints that may occur in an ascending order of an elapsed time; identifying passage time information corresponding to a selected item of the complaint from the position information storage, and identifying an urgent degree based on a difference between a current time or receipt time of the selected item of the complaint and the passage time information; upon detecting that the urgent degree is equal to or greater than a predetermined level, transmitting a notice to an employee identified for an urgent treatment in addition to a handling person of the selected item of the complaint.

Thus, it is possible to identify the urgent degree by supposing the size of the customer's complaint, and speedily take any action against the complaint according to the urgent degree.

Incidentally, it is possible to create a program for causing a computer to execute the complaint processing method according to the present invention. The program is stored into a storage medium or a storage device such as, for example, a flexible disk, a CD-ROM, a magneto-optical disk, a semiconductor memory, or a hard disk. In addition, the program may be distributed as digital signals over a network in some cases. Incidentally, data under processing is temporarily stored in the storage device such as a computer memory.

### BRIEF DESCRIPTION OF THE DRAWINGS

FIG. 1 is a system outline diagram in an embodiment of this invention;

FIG. 2 is a diagram showing an example of data stored in a complaint type master;

FIG. 3 is a diagram showing an example of data stored in a customer master;

FIG. 4 is a diagram showing an example of data stored in an employee master;

FIG. 5 is a diagram showing an example of data stored in an employee schedule master;

FIG. 6 is a diagram showing an example of data stored in a complaint master;

FIG. 7 is a diagram showing an example of data stored in a customer movement route data storage;

FIG. 8 is a diagram showing a processing flow of a movement management processing;

FIG. 9 is a diagram showing a processing flow of a complaint registration processing;

FIG. 10 is a diagram showing a processing flow of a treatment registration processing;

FIG. 11 is a diagram showing a processing flow of a processing when a customer comes to the store; and

FIG. 12 is a functional block diagram of a computer.

### DETAILED DESCRIPTION OF THE PREFERRED EMBODIMENTS

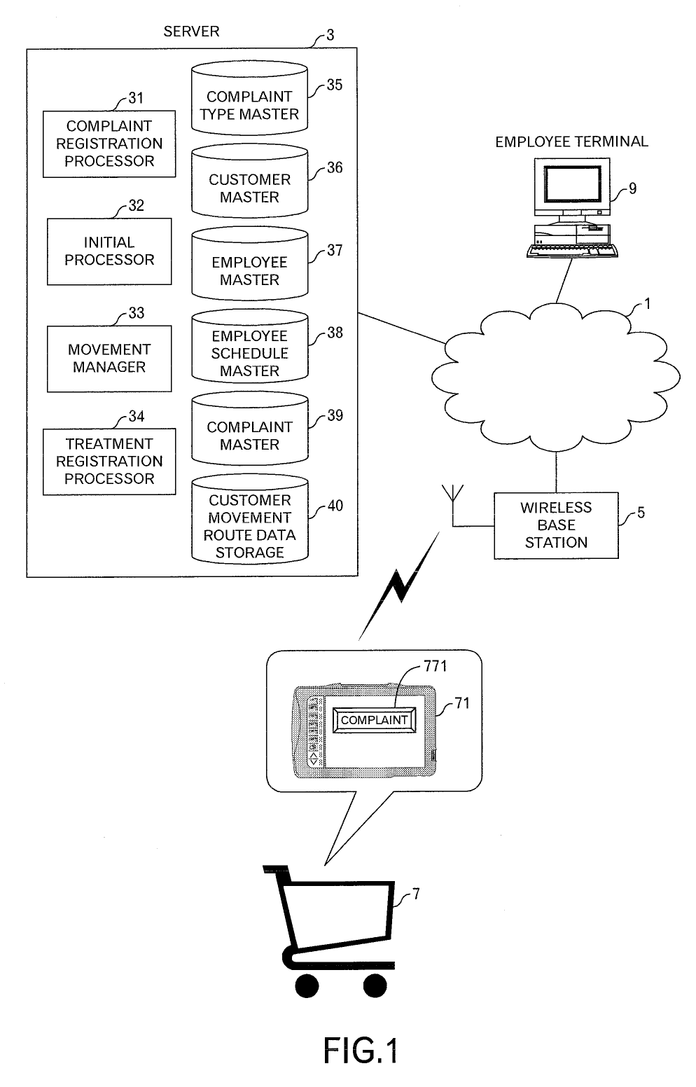

FIG. 1 shows a system outline diagram in one embodiment of this invention. For example, in a store such as a supermarket or a department store, smart carts 7, which are shopping carts, each having a terminal apparatus 71 having a display device, such as Personal Digital Assistants (PDAs), are used. This terminal apparatus 71 can communicate with a server 3 through a wireless base station 5 according to, for example, a wireless Local Area Network (LAN) standard. The wireless base station 5 is provided at various places in the store, and can communicate with the terminal apparatus 71 at the movement destination of the smart cart 7, in the wireless communication.

Furthermore, it is assumed that the position of the smart cart 7 can be grasped in the store. Because rigid accuracy for the position of the smart cart 7 is not required, the position of the smart cart 7 may be identified from the position of the wireless base station 5, which communicates with the smart cart 7 in the wireless communication, for example. In addition, a Global Positioning System (GPS) terminal may be installed into the terminal apparatus 71 when the GPS terminal can be used, and the position of the smart cart 7 may be identified periodically, for example. Furthermore, a system may be adopted that Radio Frequency (RF) IDs are embedded into floors or the like, an RF ID reader is provided for the smart cart 7 or the terminal apparatus 71, the association between the position and the RF ID are managed, and the position is identified based on the read RF ID from the association. Anyway, according to the movement of the smart cart 7, the position history of the smart cart 7 can be identified in the terminal apparatus 71, the wireless base station 5 or the server 3.

Incidentally, the terminal apparatus 71 may have an IC card insertion unit including an IC card reader, for example. By adopting such a configuration, when the customer logs in the server 3, it is possible to reduce the work of the input. In addition, although there is no direct relation with this embodiment of this invention, the terminal apparatus 71 receives various information in the store from the server 3, and displays the information on the display device. For example, the terminal apparatus 71 receives sales information and a new product advertisement according to the current position, and displays them on the display device.

In addition, the server 3 is connected with a lot of wireless base station 5 through a network 1. Furthermore, plural employee terminals 9 operated by employees in the store and the like are connected to the network 1. Then, the server 3 has a complaint registration processor 31, an initial processor 32, a movement manager 33, a treatment registration processor 34, a complaint type master 35, a customer master 36, an employee master 37, an employee schedule master 38, a complaint master 39, and a customer movement route data storage 40.

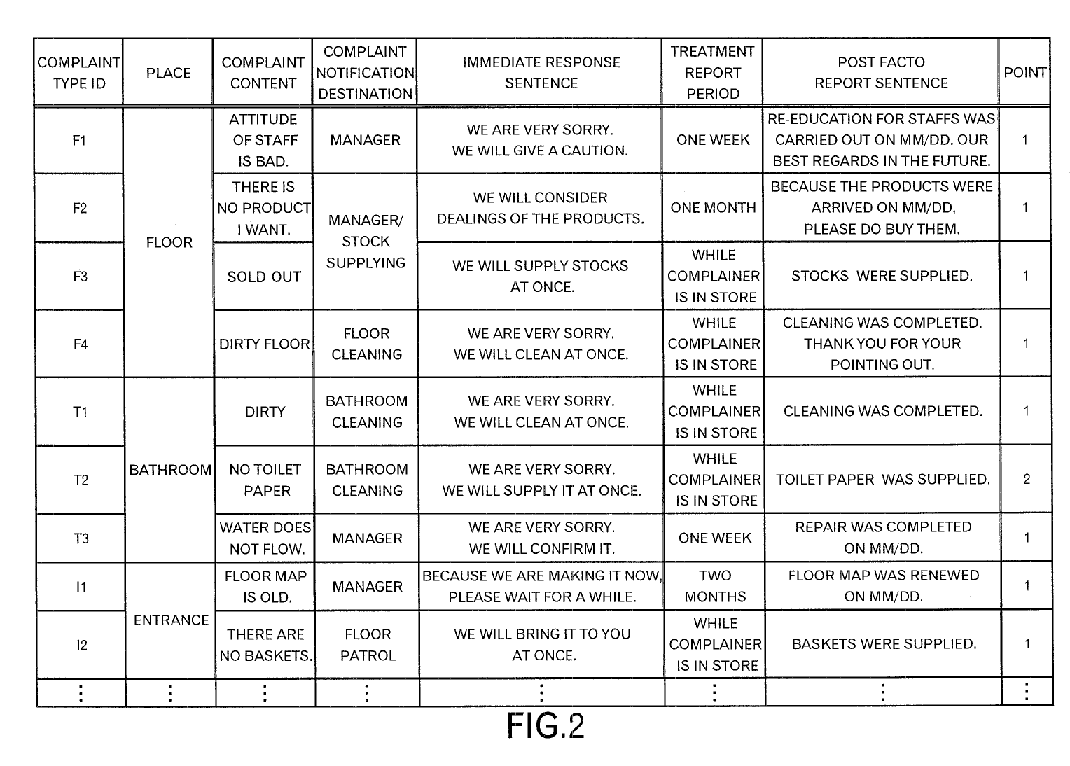

FIG. 2 shows an example of data stored in the complaint type master 35. In the table example of FIG. 2, a complaint type ID, a place, a complaint content, a name of a complaint notification destination, an immediate response sentence to be immediately replied to the customer who sends the complaint, a treatment report period, a post facto report sentence to be transmitted to the customer after the treatment, and a point are registered.

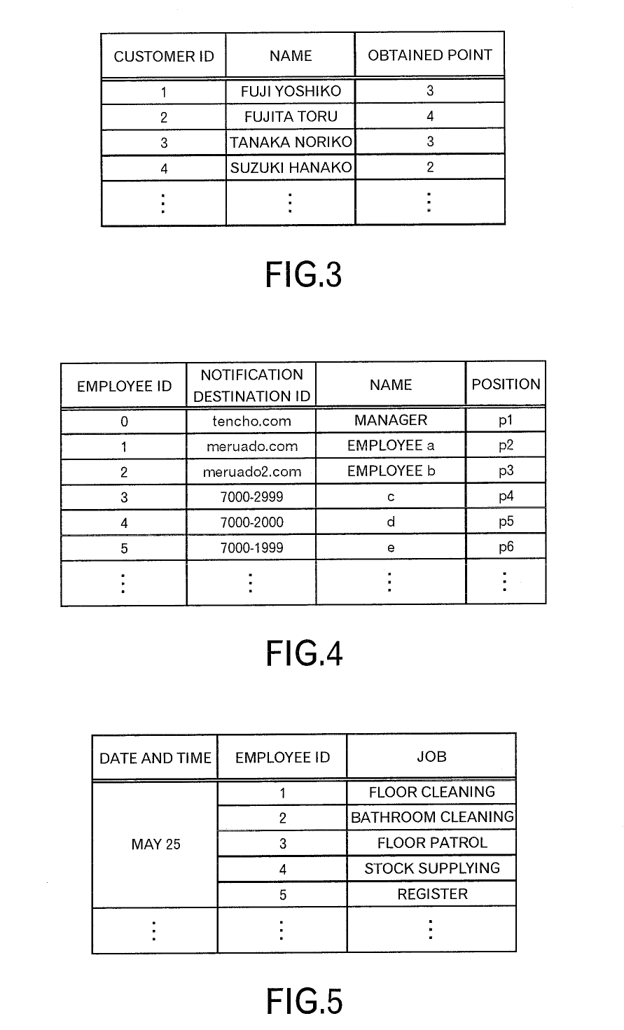

In addition, FIG. 3 shows an example of data stored in the customer master 36. In the table example of FIG. 3, a customer ID, a name, and an obtained point are registered. The point is to be exchanged later with a premium ticket as a reward for the notification of appropriate complaints. Although it is not indicated in FIG. 3, other customer information may be registered.

FIG. 4 shows an example of data stored in the employee master 37. In the table example of FIG. 4, an employee ID, a notification destination ID (e.g. mail address, telephone number or the like), a name, a current position. Incidentally, because the accuracy is not strictly required, an existing floor, not the current position, may be registered.

FIG. 5 shows an example of data stored in the employee schedule master 38. In the table example of FIG. 5, a date, an employee ID and a job are registered. For example, when “floor cleaning” is identified from the complaint type master 35, an employee whose job is “floor cleaning” in the current date can be identified.

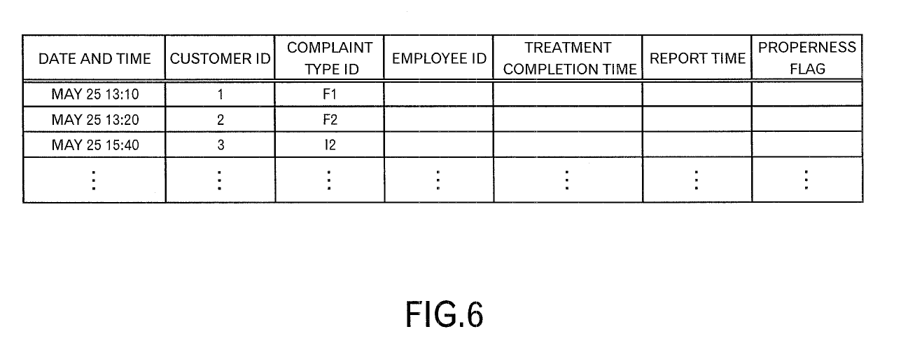

FIG. 6 shows an example of data stored in the complaint master 39. In the table example of FIG. 6, date and time when the complaint occurred, a customer ID of a customer who notified the complaint, a complaint type ID, an employee ID of an employee in charge of this complaint, a treatment completion time, a report time to the customer, a properness flag representing whether or not it was a proper complaint are registered. Incidentally, although it is not shown in FIG. 6, an ID to identify individual complaint also exists.

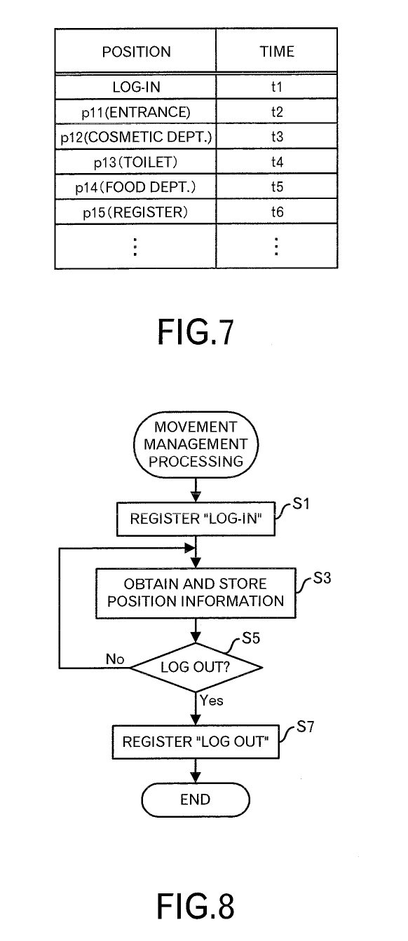

FIG. 7 shows an example of data stored in the customer movement route data storage 40. The table example of FIG. 7 shows data for one customer, and in the table example, a position and a time are registered. In a case of this customer, after log-in, he or she passed through an entrance, a cosmetic department, a bathroom, a food department and a register.

Next, a processing of the movement manager 33 will be explained by using FIG. 8. First, when an authentication processor of the server 3, which is not shown in FIG. 1, grants the customer's log-in, the authentication processor notifies the movement manager 33 of the customer ID and a terminal ID (e.g. MAC address) of the terminal apparatus 71. The movement manager 33 stores “log-in” and the current time into the customer movement route data storage 40 for the customer ID based on the notification (step S1). Then, the movement manager 33 obtains position information of the customer who logs-in, periodically or at an arbitrary timing, and stores the position information and the time into the customer movement route data storage 40 (step S3). The position information may be received from the terminal apparatus 71 as described above. In addition, such a configuration may be adopted that the terminal ID and the apparatus ID of the wireless base station 5 are received from the wireless base station 5, and the position information corresponding to the customer ID to be processed is identified from previously obtained associations between the terminal ID of the terminal apparatus 71 and the customer ID and previously obtained association between the apparatus ID of the wireless base station 5 and the position information. Furthermore, when the RF ID is received from the terminal apparatus 71, the position information may be identified from previously held associations between the RF ID and the position information.

Then, the movement manager 33 judges whether or not the customer logged out, based on information from the authentication processor (not shown) or the like (step S5). When the customer does not log out, the processing returns to the step S3. On the other hand, when it is judged that the customer logged out, the movement manager 33 stores “log out” and the current time into the customer movement route data storage 40 (step S7). However, when the data stored in the customer movement route data storage 40 is not used after the log-out, the data that has been stored for that customer ID, may be deleted at the step S7. For example, when an analysis for the customer's migration route in the store is carried out, for example, the data stored up to the step S7 can be used.

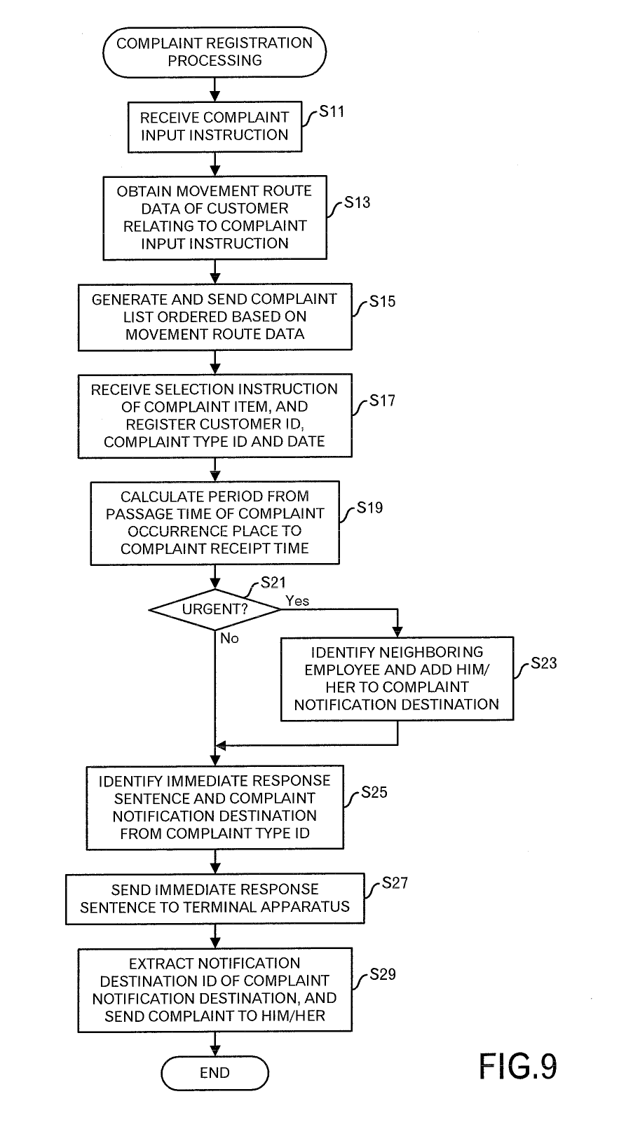

Next, a complaint registration processing will be explained by using FIG. 9. First, the terminal apparatus 71 accesses the server 3 in response to an instruction from the customer to display a menu screen, and the customer clicks a complaint button 771 in FIG. 1, which is included in the menu screen. The terminal apparatus 71 accepts the click of the complaint button 771, and transmits a complaint input instruction to the server 3. The complaint registration processor 31 of the server 3 receives the complaint input instruction from the terminal apparatus 71 (step S11). Then, the complaint registration processor 31 obtains the movement route data of the customer relating to the complaint input instruction from the customer movement route data storage 40 (step S13).

Furthermore, the complaint registration processor 31 searches the complaint type master 35 based on the movement route data, generates a complaint list in which the complaints to be selected are arranged in an ascending order of the elapsed time, and transmits page data including the generated complaint list to the terminal apparatus 71 (step S15). In the example of FIG. 7, when the present position is the “register”, the complaint items for the register are top, the complaint items for the food department are second, the complaint items for the bathroom are third, the complaint items for the cosmetic department is fourth, and the complaint items for the entrance is fifth. Although plural complaint items are included in each order, the orders of the complaint items in the same order are determined based on the registration order in the complaint type master 35 or other standard to generate the entire complaint list.

Thus, because the complaint items assumed to be the most relevant at a timing when the user decided to input the complaint are displayed on the top, it is possible to easily select the complaint item. In addition, when a complaint, which occurred a little previously in the movement route, is input, the screen is scrolled down a little, and when a complaint, which occurred quite previously in the movement route, is input, the screen is greatly scrolled down. Therefore, it is possible to present the complaint list in a form along with the time period from the complaint occurrence to the input.

The terminal apparatus 71 receives the page data including the complaint list from the server 3, and displays the page data on the display device. Then, the customer selects a pertinent complaint item. The terminal apparatus 71 accepts a selection instruction of the complaint item, and transmits the selection instruction of the complaint item to the server 3. The complaint registration processor 31 of the server 3 receives the selection instruction of the complaint item from the terminal apparatus 71, and registers the customer ID, the complaint type ID of the complaint item relating to the selection instruction, and the present time into the complaint master 39 (step S17). Furthermore, the complaint registration processor 31 identifies the passage time of the complaint occurrence place, calculates a time from the passage time of the complaint occurrence place to the receipt time of the selection instruction of the complaint item or the present time, and stores the calculated time into a storage device such as a main memory (step S19). As for the passage time of the complaint occurrence place, the place (i.e. position) corresponding to the complaint type ID of the complaint item is identified from the complaint type master 35, and furthermore, the time as the passage time is identified based on that place (i.e. position) from the customer movement route data storage 40.

Then, the complaint registration processor 31 judges whether or not the time calculated at the step S19 is in an urgent level (step S21). For example, the complaint registration processor 31 judges whether or not the time calculated at the step S19 is shorter than a predetermined threshold. When it is in the urgent level, the complaint registration processor 31 identifies a neighboring employee from the employee master 37, and adds the identified neighboring employee to the complaint notification destination (step S23). Because the employee master 37 holds the position information of the respective employees, the notification destination ID of the neighboring employee is identified based on the current position stored in the customer movement route data storage 40, and is stored into the storage device such as the main memory. However, the neighboring employee may be an employee on the same floor, and may be an employee in charge of the service. After that the processing shifts to step S25. On the other hand, when it is not in the urgent level, the processing shifts to the step S25.

Then, the complaint registration processor 31 identifies the immediate response sentence and the complaint notification destination from the complaint type master 35 based on the complaint type ID of the complaint item (step S25). Then, the complaint registration processor 31 transmits the immediate response sentence to the terminal apparatus 71, which is a transmission source of the complaint item (step S27). The terminal apparatus receives the immediate response sentence and displays the sentence on the display device. For example, a message “We are very sorry. We will clean at once.” is displayed on the display device of the terminal apparatus 71.

In addition, the complaint registration processor 31 identifies the employee ID of the complaint notification destination at the current time from the employee schedule master 38 based on the identified complaint notification destination, extracts the notification destination ID from the employee master 37, and notifies the notification destination ID of the complaint (step S29). Incidentally, in a case of the complaint notification destination identified at the step S23, the notification destination ID can already be identified without referring to the employee schedule master 38. Moreover, the employee ID of the employee who is in charge of this complaint and was identified at the step S29, is registered into the pertinent record of the complaint master 39.

By carrying out such a processing, when it is not urgent, the complaint is notified to the employee in charge of this problem and when it is urgent, the complaint is notified to the neighboring employee in addition to the employee in charge of this problem. Incidentally, it is preferable to include information concerning the terminal ID (or ID of the smart cart 7) of the terminal apparatus 71, the name of the customer or the like in the notification of the complaint. Then, the neighboring employee can find out the pertinent terminal apparatus 71, smart cart 7 or customer to apologize to him or her and get information concerning the state from him or her, and then can immediately conduct an appropriate action.

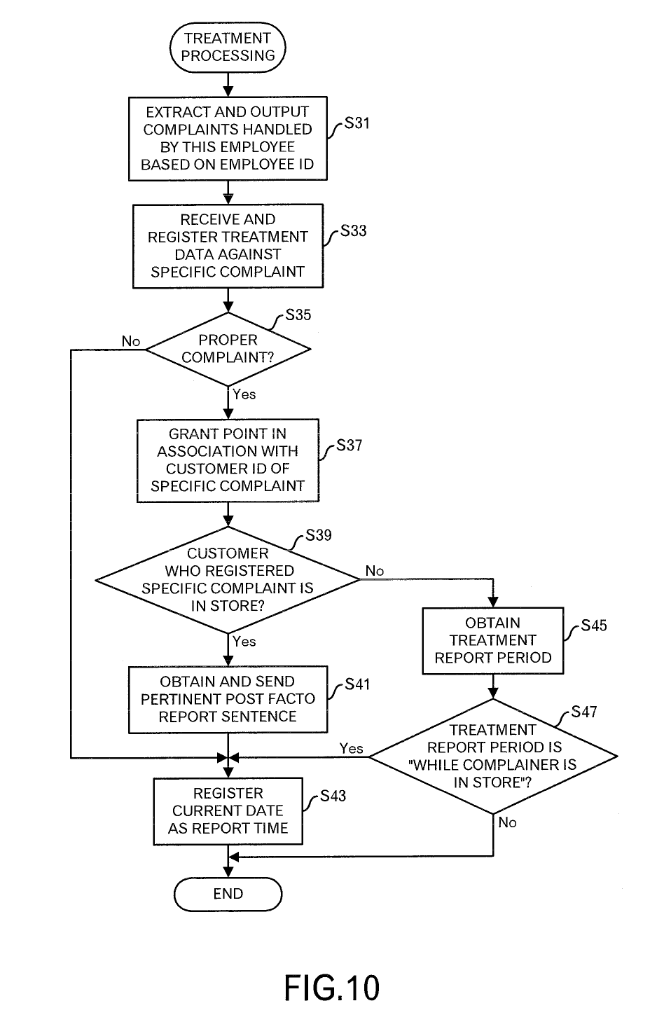

Next, a treatment processing against the complaint will be explained by using FIG. 10. For example, the employee who handled the complaint operates the employee terminal 9 to log in the server 3. The authentication processing for the login is carried out by the authentication processor (not shown). The employee ID input at the login is output to the treatment registration processor 34. The treatment registration processor 34 searches the complaint master 39 by the employee ID to extract the complaints handled by the employee, and outputs the extracted complaints to the employee terminal 9 (step S31). The employee terminal 9 receives a list of the complaints handled by the employee and displays the list on the display device. For example, in association with each complaint, an input column for the treatment completion time, a check box of the properness flag and the like are simultaneously displayed, and the employee inputs the treatment completion time for the complaint for which any action was conducted, and sets or resets the properness flag according to the appropriateness of the complaint. Then, by clicking a send button, the employee causes the employee terminal 9 to transmit treatment data including identification information of the complaint for which any action was conducted, the treatment completion time and the properness flag to the server 3.

The treatment registration processor 34 of the server 3 receives the treatment data against the specific complaint from the employee terminal 9, and registers the received data into the complaint master 39 (step S33). That is, the treatment registration processor 34 registers the treatment completion time, and sets or resets the properness flag. Then, the treatment registration processor 34 judges whether or not the specific complaint is an appropriate complaint, based on whether or not the properness flag for the specific complaint is set (step S35). When the specific complaint is an inappropriate complaint, the processing shifts to step S43 because the point grant for the customer is not necessary.

On the other hand, when the properness flag is set, the treatment registration processor 34 grants a point and registers the point in association with the customer ID of the specific complaint into the customer master 36 (step S37). That is, the point value registered in the complaint type master 35 in association with the complaint type ID is added to the point value registered in the customer master 36 in association with the customer ID of the specific complaint, and the point value after the addition is overwritten into the customer master 36.

Then, the treatment registration processor 34 judges by referring to the customer movement route data storage 40 whether or not the customer who registers the specific complaint is in the store (step S39). That is, it is judged whether or not he or she has been logged in. When he or she has been logged in, the treatment registration processor 34 searches the complaint type master 35 by the complaint type ID of the specific complaint to obtain a pertinent post facto report sentence, and transmits a message including the post facto report sentence to the terminal apparatus 71 of the smart cart 7 the customer uses (step S41). The terminal apparatus 71 receives the message including the post facto report sentence from the server 3, and displays the message on the display device. Thus, the customer can know the completion of the treatment against the customer's complaint.

In addition, the treatment registration processor 34 registers the current date as the report time in association with the specific complaint in the complaint master 39 (step S43). Thus, the completion of the post fact report is also registered.

On the other hand, when the customer who registered the specific complaint is not in the store, the treatment registration processor 34 searches the complaint type master 35 by the complaint type ID of the specific complaint to obtain the treatment report period (step S45). Here, the treatment registration processor 34 judges whether or not the treatment report period is “while the complainer is in the store” (step S47). When the treatment report period is “while the complainer is in the store”, the processing shifts to the step S43. On the other hand, when the treatment report period is not “while the complainer is in the store”, the processing is completed.

By carrying out such a processing, it becomes possible to send a post facto report to the complaint for which any action was completed to the customer, appropriately.

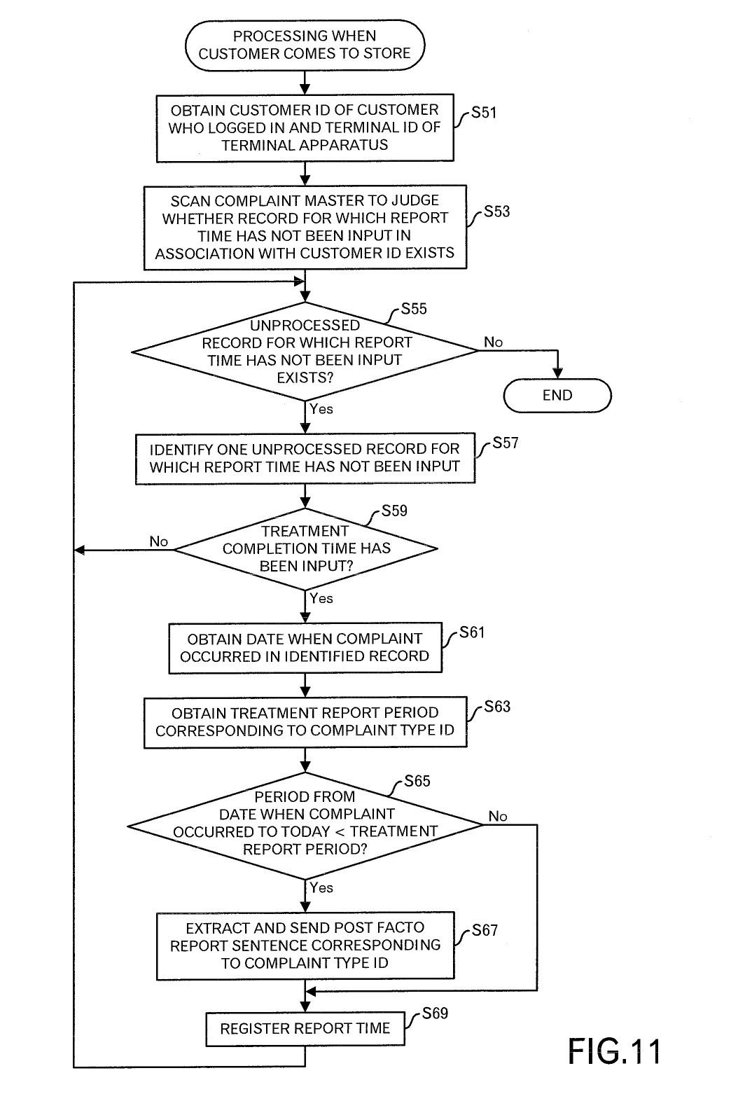

Next, a processing when a customer comes to the store will be explained by using FIG. 11. First, the initial processor 32 obtains, from the authentication processor (not shown) or the like, the customer ID of the customer who logged in and the terminal ID of the terminal apparatus 71, and stores the customer ID and the terminal ID into the storage device such as the main memory (step S51). Then, the initial processor 32 scans the complaint master 39 in order to confirm whether or not a record for which the report time has not been input in association with that customer ID exists (step S53). When there is no unprocessed record for which the report time has not been input in association with that customer ID (step S55: No route), the processing is terminated.

On the other hand, when there is an unprocessed record for which the report time has not been input in association with that customer ID (step S55: Yes route), the initial processor 32 identifies one record for which the report time has not been input in association with that customer ID (step S57). Then, the initial processor 32 judges whether or not the treatment completion time has been input in that record (step S59). When the treatment completion time is not input, the processing returns to the step S55 because it is a complaint for which the treatment has not been completed.

On the other hand, when the treatment completion time has been input, the initial processor 32 obtains the date when the complaint occurred in the record identified at the step S57 (step S61). Then, the initial processor 32 searches the complaint type master 35 by the complaint type ID of the identified record to obtain the corresponding treatment report period, and stores the obtained treatment report period into the storage device such as the main memory (step S63). Then, the initial processor 32 judges whether or not a period from the date when the complaint occurred to today is shorter than the obtained treatment report period (step S65). That is, it is judged whether or not a state where the customer comes to the store within the treatment report period and the report can be sent has come. However, even when such a state has come, it is impossible to send the report unless the customer comes to the store within the treatment report period. When the period from the date when the complaint occurred to today is longer than the treatment report period, the processing shifts to step S69.

When the period from the date when the complaint occurred to today is shorter than the treatment report period, the initial processor 32 searches the complaint type master 36 by the complaint type ID to extract the corresponding post facto report sentence, and transmits a message including the extracted post facto report sentence to the terminal apparatus 71 used by the customer who logged in (step S67). Then, the initial processor 32 registers the current time as the report time into the complaint master 39 (step S69). After that, the processing returns to the step S55.

By carrying out the aforementioned processing, when there is any complaint for which the post facto report should be sent when the relevant customer comes to the store, it is possible to send the post facto report to the relevant customer.

As described above, because it is possible for the customer to submit the complaint against the store much easily, the store can immediately take actions for the customer's complaint to raise the customer satisfaction.

Although the embodiment of this invention is explained, this invention is not limited to this embodiment. For example, the functional blocks of the server 3, which are shown in FIG. 1, are mere examples, and there is a case where they do not correspond to the actual program configuration and the actual file configuration.

In addition, as for the processing flows, when the processing result is the same, it is possible to rearrange the order of the steps and execute two or more steps in parallel.

Furthermore, it is also possible to adopt such a configuration that the terminal apparatus 71 itself, not the smart cart 7, is rented to the customer. Furthermore, the complaint may be input by using the customer's cellular phone. At that time, the customer is also prompted to input the complaint occurrence place, for example. Furthermore, a particular application program may be installed into a cellular phone with a GPS function, and may cause the cellular phone to transmit the position information to the server 3 periodically.

In addition, although an example that the server 3 has the main functions is described, the server 3 and the terminal apparatus 71 may share the functions.

Incidentally, although an example of judging whether or not the complaint is in the urgent level is described, there is a case where plural urgent levels are defined, and the number of employees or the rank of the employee to which the notification is carried out is changed according to the urgent level.

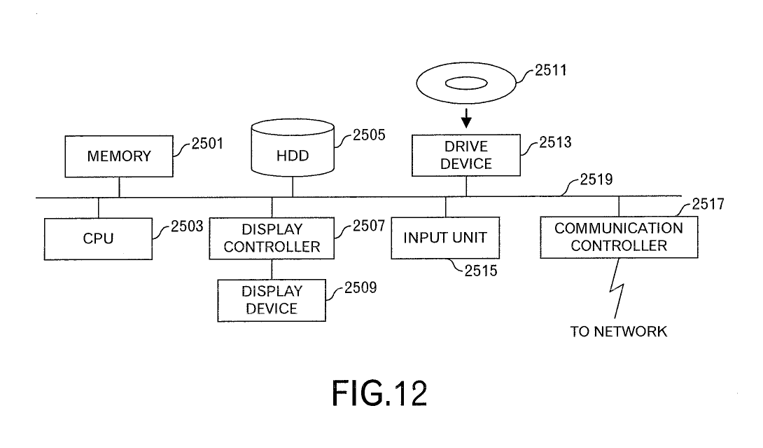

Incidentally, the server 3, the employee terminal 9, and the terminal apparatus 71 are computer devices as shown in FIG. 12. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 12. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in detail are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A complaint processing method, comprising:
receiving a complaint input instruction from a user terminal;
obtaining position information of said user terminal;
searching, based on said position information of said user terminal, a first data storage storing items of complaints that may occur in association with position information to identify items of complaints that may occur and correspond to said position information of said user terminal;
transmitting the identified items of said complaints that may occur and correspond to said position information of said user terminal to said user terminal; and
receiving information concerning a selected item of said complaint from said user terminal, and storing said information concerning the selected item of said complaint into a second data storage.

2. The complaint processing method as set forth in claim 1, wherein said obtaining comprises obtaining past position information of said user terminal, and
said searching comprises searching, based on said past position information of said user terminal, said first data storage to identify items of complaints that may occur and correspond to said past position information of said user terminal, and
said complaint processing method further comprises:
arranging the identified items of said complaints that may occur in an ascending order of an elapsed time.

3. The complaint processing method as set forth in claim 1, wherein said obtaining comprises obtaining past position information of said user terminal and passage time information, and
said searching comprises searching, based on said past position information of said user terminal, said first data storage to identify items of complaints that may occur and correspond to said past position information of said user terminal, and
said complaint processing method further comprises:
arranging the identified items of said complaints that may occur in an ascending order of an elapsed time;
identifying passage time information corresponding to an item of a complaint, which is selected by a customer, and identifying an urgent degree based on a difference between a current time or receipt time of the selected item of said complaint and said identified passage time information; and
upon detecting that said urgent degree is equal to or greater than a predetermined level, transmitting a notice to an employee for an urgent treatment in addition to a handling employee of the selected item of said complaint.

4. A program embodied on a computer-readable medium, for causing a computer to execute a complaint processing method, said program comprising:
receiving a complaint input instruction from a user terminal;
obtaining position information of said user terminal;
searching, based on said position information of said user terminal, a first data storage storing items of complaints that may occur in association with position information to identify items of complaints that may occur and correspond to said position information of said user terminal;
transmitting the identified items of said complaints that may occur and correspond to said position information of said user terminal to said user terminal; and
receiving information concerning a selected item of said complaint from said user terminal, and storing said information concerning the selected item of said complaint into a second data storage.

5. The program as set forth in claim 4, wherein said obtaining comprises obtaining past position information of said user terminal, and
said searching comprises searching, based on said past position information of said user terminal, said first data storage to identify items of complaints that may occur and correspond to said past position information of said user terminal, and
said program further comprises:
arranging the identified items of said complaints that may occur in an ascending order of an elapsed time.

6. The program as set forth in claim 4, wherein said obtaining comprises obtaining past position information of said user terminal and passage time information, and
said searching comprises searching, based on said past position information of said user terminal, said first data storage to identify items of complaints that may occur and correspond to said past position information of said user terminal, and
said program further comprises:
arranging the identified items of said complaints that may occur in an ascending order of an elapsed time;
identifying passage time information corresponding to an item of a complaint, which is selected by a customer, and identifying an urgent degree based on a difference between a current time or receipt time of the selected item of said complaint and said identified passage time information;
upon detecting that said urgent degree is equal to or greater than a predetermined level, transmitting a notice to an employee for an urgent treatment in addition to a handling employee of the selected item of said complaint.

7. A complaint processing apparatus, comprising:
a unit that receiving a complaint input instruction from a user terminal;
an obtaining unit that obtains position information of said user terminal;
a searching unit that searches, based on said position information of said user terminal, a first data storage storing items of complaints that may occur in association with position information to identify items of complaints that may occur and correspond to said position information of said user terminal;
a unit that transmits the identified items of said complaints that may occur and correspond to said position information of said user terminal to said user terminal; and
a unit that receives information concerning a selected item of said complaint from said user terminal, and stores said information concerning the selected item of said complaint into a second data storage.

8. The complaint processing apparatus as set forth in claim 7, wherein said obtaining unit obtains past position information of said user terminal, and
said searching unit searches, based on said past position information of said user terminal, said first data storage to identify items of complaints that may occur and correspond to said past position information of said user terminal, and
said complaint processing apparatus further comprises:
a unit that arranges the identified items of said complaints that may occur in an ascending order of an elapsed time.

9. The complaint processing apparatus as set forth in claim 7, wherein said obtaining unit obtains past position information of said user terminal and passage time information, and
said searching unit searches, based on said past position information of said user terminal, said first data storage to identify items of complaints that may occur and correspond to said past position information of said user terminal, and
said complaint processing apparatus further comprises:
a unit that arranges the identified items of said complaints that may occur in an ascending order of an elapsed time;
a unit that identifies passage time information corresponding to an item of a complaint, which is selected by a customer, and identifying an urgent degree based on a difference between a current time or receipt time of the selected item of said complaint and said identified passage time information; and
a unit that transmits, upon detecting that said urgent degree is equal to or greater than a predetermined level, a notice to an employee for an urgent treatment in addition to a handling employee of the selected item of said complaint.
